(19) United States
(12) Patent Application Publication
(10) Pub. No.: US 2026/0169403 A1
(43) Pub. Date: Jun. 18, 2026

(54) IMAGE FORMING APPARATUS

(71) Applicant: KYOCERA Document Solutions Inc., Osaka (JP)

(72) Inventors: Masataka OKADA, Osaka (JP); Kiyotaka KOBAYASHI, Osaka (JP); Hiroshi YAMAZAKI, Osaka (JP)

(73) Assignee: KYOCERA Document Solutions Inc., Osaka (JP)

(21) Appl. No.: 19/418,598

(22) Filed: Dec. 12, 2025

(30) Foreign Application Priority Data
Dec. 16, 2024 (JP) 2024-220241

(51) Int. Cl. G03G 15/09; G03G 5/082; G03G 15/01; G03G 15/16; H01F 1/059

(52) U.S. Cl. CPC G03G 15/0921; G03G 5/08214; G03G 15/0121; G03G 15/0131; G03G 15/0189; G03G 15/0942; G03G 15/162; G03G 15/167; H01F 1/059; G03G 2215/0609

(57) ABSTRACT

An intermediate transfer belt is a hard resin belt, and a developer carrying member includes a rotatable development sleeve and a magnet. The development sleeve carries a developer, and a magnetic brush is formed on its surface. In the magnet, a plurality of magnetic poles that are fixed in the development sleeve so as not to rotate and include a main pole disposed in a development region opposite an image carrying member relative to the direction of rotation of the development sleeve are spaced at predetermined intervals in a circumferential direction. A horizontal magnetic force gradient in a position where the horizontal magnetic force of the main pole is 0 [mT] is A, |A|≥3.74 is satisfied.

### INCORPORATION BY REFERENCE

This application is based upon and claims the benefit of priority from the corresponding Japanese Patent Application No. 2024-220241 filed on Dec. 16, 2024, the entire contents of which are incorporated herein by reference.

### BACKGROUND

The present disclosure relates to image forming apparatuses such as a copying machine, a printer and a facsimile which include an image carrying member and a multifunctional peripheral thereof, and particularly relates to an image forming apparatus of a two-component development system which uses a two-component developer including a toner and a carrier.

A conventional image forming apparatus includes an image carrying member, a development device, an intermediate transfer belt and a secondary transfer roller. The development device develops an electrostatic latent image formed on the surface of the image carrying member into a toner image. The toner image formed on the image carrying member is primarily transferred to the intermediate transfer belt. The secondary transfer roller secondarily transfers the toner image primarily transferred to the intermediate transfer belt onto a recording medium. The intermediate transfer belt is a hard resin belt, and does not include an elastic layer.

However, in the configuration described above, when a hard resin belt is used as the intermediate transfer belt, carrier development may easily occur on the white background part of a photosensitive member.

An object of the present disclosure is to provide an image forming apparatus which can suppress carrier development in a two-component development system.

### SUMMARY

In order to achieve the object described above, a first configuration of the present disclosure is an image forming apparatus which includes an image carrying member, a charging device, an exposure device, a development device, an intermediate transfer belt, a primary transfer roller and a secondary transfer roller. In the image carrying member, a photosensitive layer is formed on a surface. The charging device charges the surface of the image carrying member. The exposure device exposes the surface of the image carrying member charged by the charging device to form an electrostatic latent image on the surface of the image carrying member. The development device develops the electrostatic latent image formed on the surface of the image carrying member into a toner image. The toner image formed on the image carrying member is primarily transferred to the intermediate transfer belt. The primary transfer roller is pressed against the image carrying member via the intermediate transfer belt. The secondary transfer roller secondarily transfers the toner image primarily transferred to the intermediate transfer belt onto a recording medium. The intermediate transfer belt is a hard resin belt. The development device includes a development container and a developer carrying member. The development container contains a two-component developer including a magnetic carrier and a toner. The developer carrying member is rotatably supported by the development container and carries the developer on an outer circumferential surface. The developer carrying member includes a rotatable development sleeve and a magnet. The development sleeve carries the developer, and a magnetic brush is formed on a surface. In the magnet, a plurality of magnetic poles that are fixed in the development sleeve so as not to rotate and include a main pole disposed in a development region opposite the image carrying member relative to the direction of rotation of the development sleeve are spaced at predetermined intervals in a circumferential direction. When a horizontal magnetic force gradient in a position where a horizontal magnetic force of the main pole is 0 [mT] is A, |A|≥3.74 is satisfied.

Further objects of the present disclosure and specific advantages obtained by the present disclosure will become clearer from the following description of an embodiment.

### BRIEF DESCRIPTION OF THE DRAWINGS

FIG. 1 is a side cross-sectional view showing an internal configuration of an image forming apparatus 100 according to an embodiment of the present disclosure;

FIG. 2 is a side cross-sectional view of a development device 3a in the image forming apparatus 100 according to the embodiment of the present disclosure; and

FIG. 3 is a graph showing variations in vertical magnetic force distribution, horizontal magnetic force distribution and a horizontal magnetic force gradient in the circumferential direction of a development roller 30 in the image forming apparatus 100 according to the embodiment of the present disclosure.

### DETAILED DESCRIPTION

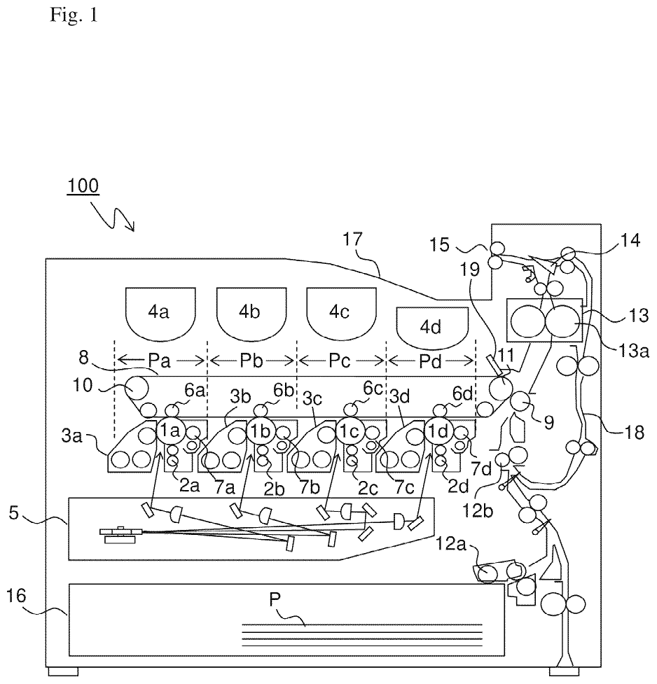

An embodiment of the present disclosure will be described below with reference to drawings. FIG. 1 is a cross-sectional view showing an internal structure of an image forming apparatus 100 which includes development devices 3a to 3d in the present disclosure. In the main body of the image forming apparatus 100 (here, a color printer), four image formation units Pa, Pb, Pc and Pd are arranged sequentially from an upstream side (left side in FIG. 1) in a conveyance direction. These image formation units Pa to Pd are provided to correspond to images of four different colors (yellow, cyan, magenta and black), and sequentially form the images of yellow, cyan, magenta and black, respectively, in steps of charging, exposure, development and transfer.

In these image formation units Pa to Pd, photosensitive drums (image carrying members) 1a, 1b, 1c and 1d which carry visible images (toner images) of the colors are arranged. Furthermore, an intermediate transfer belt (intermediate transfer member) 8 which is rotated counterclockwise in FIG. 1 by a belt drive motor (not shown) is provided adjacent to the image formation units Pa to Pd.

The toner images formed on these photosensitive drums 1a to 1d are primarily transferred and superimposed in a sequential manner onto the intermediate transfer belt 8 which is moved in contact with the photosensitive drums 1a to 1d. Thereafter, the toner images primarily transferred onto the intermediate transfer belt 8 are secondarily transferred by a secondary transfer roller 9 onto a transfer sheet P which is an example of a recording medium. Furthermore, in the transfer sheet P to which the toner images have been secondarily transferred, the toner images are fixed in a fixing unit 13, and then the transfer sheet P is ejected from the main body of the image forming apparatus 100. While the photosensitive drums 1a to 1d are being rotated clockwise in FIG. 1, an image formation process is performed on the photosensitive drums 1a to 1d.

The transfer sheet P to which the toner images are secondarily transferred is stored in a sheet cassette 16 disposed in a lower part of the main body of the image forming apparatus 100, and is conveyed to a nip portion between the secondary transfer roller 9 and a driving roller 11 for the intermediate transfer belt 8 via a paper feed roller 12a and a registration roller pair 12b. The intermediate transfer belt 8 is a hard resin belt which does not include an elastic layer, and a seamless belt is mainly used. On the downstream side of the secondary transfer roller 9, a belt cleaner 19 is disposed which removes the toners and the like left on the surface of the intermediate transfer belt 8 and is in the shape of a blade. In the present embodiment, the belt cleaner 19 brings the blade into contact with the intermediate transfer belt 8 of the hard resin belt to remove the toners and the like. In this way, as compared with roller cleaning which is performed on an intermediate transfer belt of an elastic belt, it is possible to simplify the configuration of the belt cleaner 19 to reduce manufacturing costs.

The intermediate transfer belt 8 is preferably a resin belt the surface hardness of which is equal to or greater than 180 N/mm². For example, the intermediate transfer belt 8 is formed with a resin belt which does not include an elastic layer of polyurethane or the like. Examples of the material of the intermediate transfer belt 8 include polycarbonate, polyvinylidene fluoride, polyamide, acrylic, nylon, polyimide and polyamideimide. In the present disclosure, the material of the resin belt of the intermediate transfer belt 8 is not particularly limited. As the intermediate transfer belt 8, the resin belt the surface hardness of which is equal to or greater than 180 N/mm² is used, and thus it is possible to reduce the thickness of the intermediate transfer belt 8 and to suppress the occurrence of color misregistration. In this way, it is possible to enhance the image quality.

The image formation units Pa to Pd will then be described. In each of the photosensitive drums 1a to 1d which are rotatably arranged, a photosensitive layer (not shown) is formed on its surface, and in the present embodiment, as the photosensitive layer, amorphous silicon (a-Si) which has a high relative permittivity is used. As the photosensitive layer, amorphous silicon is used, and thus a film of the photosensitive layer is unlikely to be peeled off as compared with an organic photosensitive member. In this way, it is possible to enhance the durability of the photosensitive drums 1a to 1d to extend the life of the unit.

Around and below the photosensitive drums 1a to 1d, charging devices 2a, 2b, 2c and 2d which charge the photosensitive drums 1a to 1d, an exposure device 5 which exposes image information to the photosensitive drums 1a to 1d, the development devices 3a to 3d which form the toner images on the photosensitive drums 1a to 1d and cleaning devices 7a, 7b, 7c and 7d which remove developers (toners) and the like left on the photosensitive drums 1a to 1d are provided.

When image data is input from a host device such as a personal computer, the surfaces of the photosensitive drums 1a to 1d are first uniformly charged by the charging devices 2a to 2d. Then, the exposure device 5 applies light according to the image data to form electrostatic latent images corresponding to the image data on the photosensitive drums 1a to 1d. Predetermined amounts of two-component developers including the toners of yellow, cyan, magenta and black are filled in the development devices 3a to 3d. When the ratio of the toner in the two-component developer filled in each of the development devices 3a to 3d falls below a specified value due to the formation of the toner image which will be described later, the toner is supplied from the corresponding one of the toner containers 4a to 4d to the corresponding one of the development devices 3a to 3d. The toner in the developer described above is supplied onto the corresponding one of the photosensitive drums 1a to 1d by the corresponding one of the development devices 3a to 3d, and is electrostatically adhered thereto. In this way, the toner images corresponding to the electrostatic latent images formed by the exposure from the exposure device 5 are formed.

Then, an electric field is applied between the primary transfer rollers 6a to 6d and the photosensitive drums 1a to 1d at a predetermined transfer voltage by the primary transfer rollers 6a to 6d, and thus the toner images of yellow, magenta, cyan and black on the photosensitive drums 1a to 1d are primarily transferred onto the intermediate transfer belt 8. These images are formed in a predetermined positional relationship. Thereafter, in preparation for the subsequent formation of new electrostatic latent images, the toners and the like left on the surfaces of the photosensitive drums 1a to 1d after the primary transfer are removed by the cleaning devices 7a to 7d.

The intermediate transfer belt 8 is stretched over a driven roller 10 on the upstream side and the driving roller 11 on the downstream side, when the intermediate transfer belt 8 starts to rotate counterclockwise as the driving roller 11 is rotated by the belt drive motor (not shown), the transfer sheet P is conveyed from the registration roller pair 12b to the nip portion (secondary transfer nip portion) between the driving roller 11 and the secondary transfer roller 9 provided adjacent thereto at a predetermined timing and the toner images on the intermediate transfer belt 8 are secondarily transferred onto the transfer sheet P. The transfer sheet P to which the toner images have been secondarily transferred is conveyed to the fixing unit 13.

The transfer sheet P conveyed to the fixing unit 13 is heated and pressurized by a fixing roller pair 13a, and thus the toner images are fixed on the surface of the transfer sheet P, with the result that a predetermined full color image is formed. The transfer sheet P on which the full color image has been formed is distributed with a branch unit 14 which branches into a plurality of directions, and is ejected without being processed (or after being fed to a double-sided conveyance path 18 where images are formed on both sides) to an ejection tray 17 with an ejection roller pair 15.

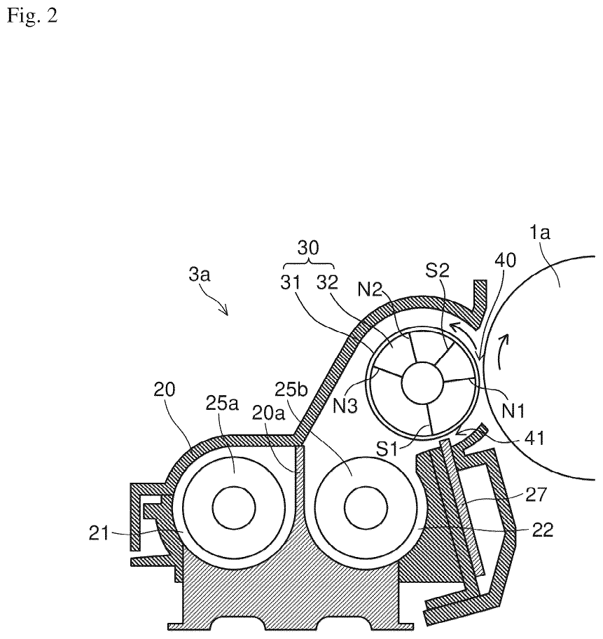

FIG. 2 is a side cross-sectional view of the development device 3a incorporated in the image forming apparatus 100. Although the development device 3a disposed in the image formation unit Pa shown in FIG. 1 is described below as an example, the configurations of the development devices 3b to 3d disposed in the image formation units Pb to Pd are basically the same, and thus the description thereof is omitted.

As shown in FIG. 2, the development device 3a includes a development container 20, a development roller (developer carrying member) 30, a restriction blade 27, a stirring conveyance screw 25a and a supply conveyance screw 25b. The development container 20 stores the two-component developer (hereinafter simply referred to as the developer) which includes the magnetic carrier and the toner. The development container 20 is partitioned into a stirring conveyance chamber 21 and a supply conveyance chamber 22 by a partition wall 20a. In the stirring conveyance chamber 21 and the supply conveyance chamber 22, a stirring conveyance screw 25a and a supply conveyance screw 25b for mixing, stirring and charging the toner and the magnetic carrier supplied from a toner container 4a (see FIG. 1) are respectively provided to be rotatable. In the present embodiment, the two-component developer which includes the positively charged toner and the ferrite/resin coated carrier is used. The detailed configuration of the carrier will be described later.

The developer is conveyed in an axial direction (direction perpendicular to the plane of FIG. 2) while being stirred by the stirring conveyance screw 25a and the supply conveyance screw 25b, and is circulated between the stirring conveyance chamber 21 and the supply conveyance chamber 22 via unillustrated developer passages formed at both ends of the partition wall 20a. In other words, the stirring conveyance chamber 21, the supply conveyance chamber 22 and the developer passages form the circulation path of the developer in the development container 20.

The development container 20 extends diagonally upward to the right in FIG. 2, and the development roller 30 is disposed diagonally above the right of the supply conveyance screw 25b in the development container 20. A part of the outer circumferential surface of the development roller 30 is exposed from the opening of the development container 20, and is opposite the photosensitive drum 1a with a predetermined distance (development gap) from the part to form a development region 40. The development roller 30 is rotated counterclockwise in FIG. 2 (trailing rotation in the position opposite the photosensitive drum 1a).

The development roller 30 includes a cylindrical development sleeve 31 which is rotated counterclockwise in FIG. 2 and a magnet 32 including a plurality of magnetic poles which are fixed in the development sleeve 31 so as not to rotate. In the present embodiment, the development sleeve 31 with a knurled surface is used. However, it is also possible to use a development sleeve with a large number of recesses (dimples) formed in the surface, a development sleeve with a blasted surface, a development sleeve which is not only knurled and recessed but also blasted, a development sleeve which is plated in order to enhance durability, a development sleeve which is anodized or a development sleeve which is treated with a so-called secondary electrolytic coloring method in which metal salts such as Ni, Sn and Mo are applied to porous parts that have been anodized.

In particular, the development sleeve which is anodized or the development sleeve which is treated with the secondary electrolytic coloring method after being anodized not only enhances durability but also has the effect of suppressing the occurrence of development leak. This is because the surface of the development sleeve 31 is anodized, and thus a leak current generated by a magnetic brush is unlikely to be spread in a horizontal direction on the surface of the development roller 30, with the result that the leak current is prevented from developing into a large leak current involving the adjacent magnetic brush.

In the magnet 32, a plurality of magnetic poles which include a main pole N1 disposed in the development region opposite the photosensitive drum (image carrying member) 1a relative to the direction of rotation of the development sleeve 31 are spaced at predetermined intervals in a circumferential direction. In the present embodiment, the magnet 32 is formed with five poles of the main pole N1, a restriction pole (pumping pole) Si, conveyance poles S2 and N2 and a separation pole N3. When a driving force is input to the development device 3a, the development sleeve 31 is rotated but the magnet 32 is not rotated.

In the present embodiment, in the magnet 32, only the main pole N1 includes a samarium-iron-nitrogen magnet, and each of the restriction pole (pumping pole) Si, the conveyance poles S2 and N2 and the separation pole N3 includes a plastic magnet. Only the main pole N1 includes the samarium-iron-nitrogen magnet, and thus it is possible to increase the horizontal magnetic force gradient of the main pole N1 while suppressing an increase in manufacturing costs. A neodymium magnet may be used instead of the samarium-iron-nitrogen magnet.

A development voltage formed with a direct-current voltage Vdc and an alternating current voltage Vac is applied to the development roller 30 by a development voltage power supply (not shown).

The restriction blade 27 is attached in the development container 20 along the longitudinal direction of the development roller 30 (direction perpendicular to the plane of FIG. 2). A small gap is provided between the tip end of the restriction blade 27 and the surface of the development roller 30, and thus a restriction unit 41 is formed. In the present embodiment, as the restriction blade 27, a magnetic blade made of stainless steel (SUS430) is used.

A magnetic field is generated in the direction of attraction between the restriction pole S1 of the magnet 32 and the restriction blade 27, thus a magnetic brush of the developer connected between the restriction blade 27 and the development roller 30 is formed and the magnetic brush is passed through the restriction blade 27 (restriction unit 41), with the result that the layer of the magnetic brush is restricted to a desired height. Thereafter, when the development sleeve 31 is rotated counterclockwise, and thus the magnetic brush is moved to the development region 40, a magnetic field is applied by the main pole N1, and thus the magnetic brush is brought into contact with the surface of the photosensitive drum 1a, with the result that the electrostatic latent image is developed.

When the development sleeve 31 is further rotated counterclockwise, a magnetic field in a direction along the outer circumferential surface of the development sleeve 31 is applied by the conveyance poles S2 and N2 at this time, and thus the developer which has not been used for the formation of the toner image is collected on the development sleeve 31 together with the magnetic brush. Furthermore, on the separation pole N3 having the same polarity as the conveyance pole N2, the magnetic brush is separated from the development roller 30 to fall into the supply conveyance chamber 22. Then, the developer is stirred and conveyed by the supply conveyance screw 25b, and thereafter a magnetic brush is formed again on the development sleeve 31 by the magnetic field of the restriction pole S1.

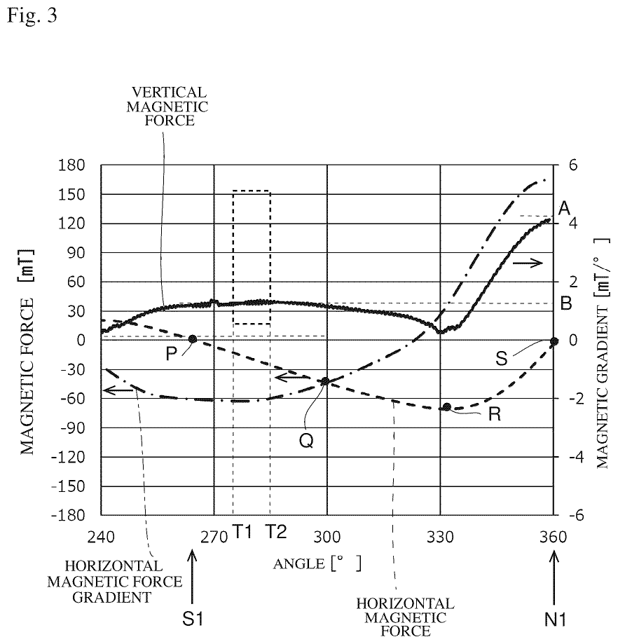

Then, the magnetic force distribution of the magnet 32 in the circumferential direction of the development roller 30 which is a feature of the present disclosure will be described. FIG. 3 is a graph showing variations in vertical magnetic force distribution, horizontal magnetic force distribution and the horizontal magnetic force gradient in the circumferential direction of the development roller 30, and shows an enlarged view from the restriction blade 27 to the main pole N1. In FIG. 3, a vertical magnetic force is indicated by a solid line, a horizontal magnetic force is indicated by a dashed line and the horizontal magnetic force gradient is indicated by alternate long and short dashed lines.

In each of the development devices 3a to 3d in the present embodiment, the magnetic force distribution of the magnet 32 in the circumferential direction of the development roller 30, more specifically, a magnetic force gradient (hereinafter referred to as the horizontal magnetic force gradient) in the circumferential direction of the horizontal magnetic force which is a magnetic force in the circumferential direction of the development roller 30 is adjusted, and thus it is possible to enhance the effect of scraping the developer using the magnetic brush to suppress carrier development.

Although as shown in FIG. 3, the horizontal magnetic force is 0 [mT] around the peak of the vertical magnetic force of the main pole N1 (point S in FIG. 3), the horizontal magnetic force gradient in the vicinity thereof is related to the scraping of the developer from the surface of each of the photosensitive drums 1a to 1d performed by the magnetic brush.

In the present embodiment, when the horizontal magnetic force gradient in a position (point S in FIG. 3) where the horizontal magnetic force of the main pole N1 is 0 [mT] is A [mT/°], |A|≥3.74 is preferably satisfied. In this way, even when a hard resin belt is used as the intermediate transfer belt 8, the horizontal magnetic force gradient of the main pole N1 is increased, and thus it is possible to suppress carrier development.

The effect of scraping on the surface of each of the photosensitive drums 1a to 1d performed by the magnetic brush is affected by the amount of developer fed to the development region 40 (developer conveyance amount). Hence, in the developer in which the developer conveyance amount is easily fluctuated, the scraping effect also varies, and thus it is impossible to obtain stable scraping performance.

The variations in the developer conveyance amount are affected by the horizontal magnetic force gradient in a position (the restriction unit 41) where the development roller 30 is opposite the restriction blade 27. Specifically, when the horizontal magnetic force gradient in the restriction unit 41 is small, a change in the vertical magnetic force is also small, and thus it is possible to decrease the influence of the magnetic force on a change in the fluidity of the developer caused by a change in the concentration of the toner in the developer or a change in the amount of charge.

In other words, in the position (the development region 40) of the main pole N1, the horizontal magnetic force gradient is increased, and thus a scraping force is increased whereas in the position (the restriction unit 41) of the restriction pole S1, the horizontal magnetic force gradient is decreased, and thus robustness (stability against noise) is enhanced, with the result that it is possible to stably suppress carrier development.

In the present embodiment, the horizontal magnetic force gradient A in the main pole N1 is set high, and thus the horizontal magnetic force gradient B in the restriction pole S1 can be set low. More specifically, horizontal magnetic force distribution is provided such that the horizontal magnetic force gradient A in the main pole N1 satisfies |A|≥3.74, and thus the horizontal magnetic force gradient B [mT/°] on the upstream side surface (T1 in FIG. 3) of the restriction blade 27 can be suppressed to |B|≤1.37. In this way, in the magnet 32, the restriction pole S1 can be formed with a magnet having a low magnetic force. Hence, it is possible to more suppress an increase in the manufacturing costs of the magnet 32 while suppressing carrier development.

The disposition of the restriction blade 27 will then be described. Between a position where the horizontal magnetic force of the restriction pole S1 is 0 [mT] (point P in FIG. 3) and a position where the horizontal magnetic force has the maximum value (point R in FIG. 3), the horizontal magnetic force acts in a direction from R toward P. Hence, when the restriction blade 27 is located on the downstream side relative to the point P, a force acts on the developer in the restriction unit 41 to return the developer in the direction of P, and thus it is possible to alleviate a developer conveyance force generated by (vertical magnetic force×coefficient of friction between the developer and the development sleeve 31). Consequently, highly robust restriction can be performed on a variation in the fluidity of the developer and the like.

On the other hand, when the downstream side surface (T2 in FIG. 3) of the restriction blade 27 is disposed on the downstream side relative to a position (point Q in FIG. 3) where the horizontal magnetic force is equal to the vertical magnetic force, the vertical magnetic force in the restriction unit 41 is reduced, and thus it impossible to ensure a sufficient magnetic restriction force. Consequently, the developer cannot be stably conveyed. Hence, the upstream side surface (T1 in FIG. 3) of the restriction blade 27 needs to be disposed on the downstream side relative to the position (point P in FIG. 3) where the horizontal magnetic force of the restriction pole Si is 0 [mT] in the direction of rotation of the development sleeve 31, and the downstream side surface (T2 in FIG. 3) of the restriction blade 27 needs to be disposed on the upstream side relative to the position (point Q in FIG. 3) where the vertical magnetic force is equal to the horizontal magnetic force.

As described above, the dispositions of the horizontal magnetic force gradient and the restriction blade 27 are specified, and thus it is possible to ensure a magnetic restriction force in the restriction unit to stably convey the developer while effectively suppressing carrier development.

A method for measuring the horizontal magnetic force gradient of the magnet 32 in the development roller 30 will then be described. In the present embodiment, the development roller 30 was fitted to an angle adjustment jig, and a horizontal magnetic force was measured using a magnetic force measurement device (GAUSS METER Model GX-100 made by Nihon Denji Sokki Co., Ltd.) while the angle adjustment jig was being rotated at fixed angular intervals. When measurement accuracy is very high, the horizontal magnetic force gradient can be determined by dividing a difference between horizontal magnetic forces measured at different angles by a measurement angle difference whereas when measurement accuracy is low, the horizontal magnetic field gradient cannot be determined accurately. Hence, in the present disclosure, the horizontal magnetic force was measured by changing a measurement angle by 0.02°, and (horizontal magnetic force difference at a difference of 0.08°/0.08°) was assumed to be a gradient of 1 at the midpoint within 0.08°.

The carrier used in the development devices 3a to 3d in the present embodiment will then be described. As the carrier, a carrier is used in which a coat layer of a silicone resin or the like is formed on the surface of a carrier core that is a magnetic particle. A silicone resin can be used in coating as a thin film, and the uniformity of a coat layer is enhanced. The thinner the coat layer, the higher the capacitance of the coat layer, and thus the effect of a ferroelectric material added to the coat layer is easily achieved.

The shape of the carrier which can be used ranges from irregular to spherical. Furthermore, the average particle diameter of the carrier which can be used is equal to or greater than 20 μm and equal to or less than 65 μm. The number average particle diameter of the carrier is set equal to or less than 65 μm, and thus the specific surface area of the carrier is increased, with the result that the amount of toner which can be carried by the carrier is increased. In this way, it is possible to keep the concentration of the toner high in the magnetic brush, and the toner is sufficiently supplied to the development roller 30, with the result that it is possible to ensure a sufficient thickness of the toner layer. Consequently, it is possible to ensure a sufficient amount of toner which is scattered from the toner layer to the electrostatic latent image on the photosensitive member, to suppress a decrease in image density and to suppress unevenness in image density. The toner is sufficiently supplied to the development roller 30, and thus a toner-deficient part is unlikely to be formed in the toner layer of the development roller 30, with the result that the occurrence of history development is suppressed.

If the average particle diameter of the carrier is less than 20 μm, carrier development occurs in which the carrier is adhered to the photosensitive drums 1a to 1d, the adhered carrier is moved to the intermediate transfer belt 8 to cause a transfer deficiency and the adhered carrier is moved to the belt cleaning device 19 to cause a cleaning failure. If the average particle diameter of the carrier is greater than 65 μm, when the toner in the two-component developer is moved from the development roller 30 to the photosensitive drums 1a to 1d, the magnetic brush in the two-component developer becomes coarse, with the result that the image quality is lowered. Examples of the carrier core include magnetic metals such as iron, nickel and cobalt, alloys thereof, alloys containing rare earth elements, hematite, magnetite, soft ferrites such as manganese-zinc ferrite, nickel-zinc ferrite, manganese-magnesium ferrite and lithium ferrite, iron oxides such as copper-zinc ferrite and mixtures thereof. The carrier core is manufactured by a known method such as a sintering method or an atomization method. Among them, ferrite carriers have satisfactory fluidity and are chemically stable, and thus they are preferably used in terms of high quality and long life.

Barium titanate particles are added to the coat layer as a ferroelectric material. Examples of a method for manufacturing barium titanate include a hydrothermal polymerization method, an oxalate method and the like, and barium titanate has different physical properties depending on the manufacturing method. Among them, barium titanate manufactured by the hydrothermal polymerization method include internal voids to have a low true specific gravity, and has sharp particle diameter distribution. Consequently, as compared with the other manufacturing methods, dispersibility is satisfactory in a coat resin, and thus uniform dispersion can be achieved. Hence, the charging performance of the carrier is also uniform, and thus barium titanate is suitable for use in the present disclosure.

The volume average particle diameter of barium titanate is preferably equal to or greater than 100 nm and equal to or less than 500 nm. When the particle diameter of barium titanate is less than 100 nm, the relative permittivity of barium titanate is rapidly lowered, and thus an effect related to the relative permittivity is reduced. On the other hand, when the particle diameter of barium titanate is equal to or greater than 500 nm, it is difficult to uniformly disperse barium titanate in the coat layer.

When 5 parts by mass or more of barium titanate relative to a coat weight is added, the effect of stabilizing the amount of charge begins to appear, and when 25 parts by mass or more is added, the effect of stabilizing the amount of charge remarkably appears. However, when the amount of barium titanate added is excessively high, all the amount cannot be contained in the coat layer to be released from the coat layer. When the released barium titanate is moved to the photosensitive drums 1a to 1d, and is caught in the edge portions of the cleaning blades (not shown) in the cleaning devices 7a to 7d, this causes a cleaning failure. In particular, in a method for mixing the toners in the toner containers 4a to 4d with the carriers to supply the mixtures to the development devices 3a to 3d, the barium titanate released through the usage is supplied to the development devices 3a to 3d, and thus a load on the cleaning blades (not shown) is increased. Hence, the amount of barium titanate added is preferably set equal to or greater than 5 parts by mass and equal to or less than 45 parts by mass.

Carbon black is added to the coat layer as a conductor. When the amount of carbon black added is excessively high, the carbon black released from the coat layer is adhered to the toner, and thus color cloudiness occurs on the colors of the toners other than black. On the other hand, when the amount of carbon black added is excessively low, charge is unlikely to be moved from the carrier to the toner, and thus the amount of charge of the toner is not increased smoothly. In the carrier in the present disclosure, carrier resistance is lowered by adding barium titanate (ferroelectric material) to the coat layer, and thus it is possible to reduce the amount of carbon black added according to the decrease in the carrier resistance.

The ferroelectric material (barium titanate) is added to the coat layer, and thus the charge retention capability of the carrier is increased, with the result that it is possible to supply sufficient charge to the toner. The conductor (carbon black) is added to the coat layer, and thus it is possible to smoothly move charge from the carrier to the toner. Due to the synergistic effect of these two factors, even if the concentration of the toner is increased, and thus the number of toner particles to be charged is increased, it is possible to supply charge up to the saturated amount of charge of the toner particles.

Barium titanate which has high hardness is added as the ferroelectric material to the coat layer of the carrier, and thus the amount of scraping of the coat layer is reduced, with the result that the life of the carrier can be extended. Barium titanate is added, and thus as compared with a case where only carbon black is added, carrier resistance is lowered, with the result that it is possible to reduce the amount of carbon black added. Consequently, it is possible to suppress color cloudiness caused by adherence of carbon black to the toner. Furthermore, since the charge supply performance of the carrier is enhanced, even if the concentration of the toner in the developer is increased, a change in the amount of charge of the toner is decreased. Consequently, the amount of charge of the toner is stabilized, and the stability of the magnetic restriction force of the restriction blade 27 is enhanced as compared with a carrier to which barium titanate is not added. Hence, the amount of developer conveyed is easily stabilized, and thus it is possible to stably suppress carrier development.

The present disclosure is not limited to the embodiment described above, and various changes can be made without departing from the spirit of the present disclosure. For example, although in the embodiment described above, as the magnet 32 of the development roller 30, the restriction pole S1 and the main pole N1 are arranged, the polarities of the restriction pole and the main pole may be reversed.

Although in the above embodiment, as an example of the image forming apparatus 100, the color printer as shown in FIG. 1 has been described, the present disclosure is not limited to a color printer, and can be applied to various image forming apparatuses including a development device of a two-component development system such as monochrome and color copying machines, a monochrome printer and a digital multifunction peripheral. The effects of the present disclosure will be more specifically described using Examples.

### Example 1

### [Manufacturing of Ferroelectric Particle-Containing Carrier]

A coat liquid was obtained by dispersing, with a homomixer, 200 parts by mass of silicone resin (KR-255 made by Shin-Etsu Chemical Co., Ltd., non-volatile content=50%), 20 parts by mass of barium titanate (made by Sakai Chemical Industry Co., Ltd., volume average particle diameter of 304 nm), 7 parts by mass of carbon black (Ketjen Black EC made by Lion Corporation) and 800 parts by mass of toluene. The resulting coat liquid was sprayed to 5 kg of carrier core (Mn ferrite carrier with a volume average particle diameter of 34.7 μm, a saturation magnetization of 80 emu/g and a coercive force of 8 Oe, made by DOWA IP Creation Co., Ltd.) using a fluidized bed coating device while was being heated at 70 to 80° C., and thus the carrier core was coated with the coat liquid. Thereafter, the carrier core was baked in an electric furnace at 200 to 250° C. for 1 hour, and was crushed and classified using a sieve after cooling, and thus a carrier containing ferroelectric particles in the coat layer was obtained.

### Example 2

[Evaluation of Carrier Development when Horizontal Magnetic Force Gradient was Changed]

An evaluation of carrier development when the horizontal magnetic force gradient of a development roller 30 was changed was performed. In a test method, development devices 3a to 3d (present disclosures 1 and 2, Comparative Example) as shown in FIG. 2 in which the vertical magnetic forces and the horizontal magnetic force gradients of a main pole N1 and a restriction pole S1 were changed were incorporated in a test machine as shown in FIG. 1. Using this test machine, carrier development when the development devices were driven in a high temperature, high humidity environment (32.5° C., 80%) and in a low temperature, low humidity environment (10° C., 15%) was evaluated.

The image formation conditions were as follows: a printing speed (process speed) was set to 55 sheets per minute, and as the development roller 30, a development sleeve 31 with an outside diameter of 20 mm and 80 rows of recesses formed (knurled) in the outer circumferential surface was used. As a restriction blade 27, a magnetic blade made of stainless steel (SUS430) having a thickness of 1.5 mm was used, and a distance (restriction gap) between the restriction blade 27 and the development roller 30 was set to 0.5±0.03 mm. The restriction blade 27 was disposed between a point P and a point Q. A development voltage was applied to the development roller 30, and the development voltage was obtained by superimposing an alternating current voltage having a peak-to-peak value (Vpp) of 1125 V, a frequency of 10 kHz and a duty of 50% on a direct current voltage of 250 V.

In photosensitive drums 1a to 1d, a photosensitive layer (not shown) was formed on the surface thereof, and as the photosensitive layer, amorphous silicon (a-Si) having a relative permittivity of 11 was used. The peripheral speed ratio of the development roller 30 relative to the photosensitive drums 1a to 1d was set to 1.8 (trailing rotation in an opposite position), and a distance (DS distance) between the photosensitive drums 1a to 1d and the development roller 30 was set to 0.375±0.025 mm. As an intermediate transfer belt 8, a hard resin belt which did not have an elastic layer was used.

As a toner, a positively charged toner having an average particle diameter of 6.8 m was used, and as a carrier, the resin-coated carrier manufactured in Example 1 was used. The initial toner concentration in the developer (weight ratio of the toner to the carrier) was set to 5% and 7%. As the developer, two types of developers, that is, an unused developer and a developer which had been used (corresponding to printing of 100000 sheets) were used.

An evaluation method for carrier development was to observe the number of carrier particles which had been moved to the photosensitive drums 1a to 1d using a magnifying glass, and when no white spots were observed, it was rated as “OK”, and when white spots were observed, it was rated as “NG”. The evaluation results are shown in Table 1 together with the vertical magnetic forces of the main pole N1 and the restriction pole S1 and the horizontal magnetic force gradients of the main pole N1 and the regulating pole S1.

TABLE 1

| | Vertical magnetic | | Horizontal magnetic | | |
|---|---|---|---|---|---|
| | force[mT] | | force gradient[mT/°] | | |
| | Main | Restriction | Main | Restriction | Carrier |
| | pole | pole | pole | pole | development |
| Present | 150.0 | 63.6 | 3.74 | 1.37 | OK |
| Invention1 | | | | | |
| Present | 163.8 | 62.8 | 4.15 | 1.37 | OK |
| Invention2 | | | | | |
| Comparative | 132.7 | 64.3 | 3.22 | 1.37 | NG |
| Example | | | | | |

As is clear from Table 1, when the horizontal magnetic force gradient A in the main pole N1 satisfied |A|≥3.74, carrier development was not observed. In this way, it was confirmed that the occurrence of carrier development was suppressed. When the horizontal magnetic force gradient B in the restriction pole S1 satisfied |B|=1.37, carrier development was also not observed. By contrast, when the horizontal magnetic force gradient A in the main pole N1 satisfied |A|<3.74, carrier development was observed.

It has been confirmed from the above results that horizontal magnetic force distribution in which the horizontal magnetic force gradient A in the main pole N1 satisfies |A|≥3.74 is provided, and thus carrier development can be effectively suppressed even if the horizontal magnetic force gradient B in the restriction pole S1 satisfies |B|≤1.37. It has also been confirmed that horizontal magnetic force distribution in which the horizontal magnetic force gradient A in the main pole N1 satisfies |A|≥3.74 is provided, carrier development can be effectively suppressed even if amorphous silicon (a-Si) having a large carrier development amount is used for the photosensitive drum (image carrying member).

Although here, the results obtained by using the resin coat carrier to which barium titanate manufactured in Example 1 was added as the ferroelectric particle are shown, it has been confirmed that the same effects are obtained even when other carriers are used.

The present disclosure can be utilized for the development device of a two-component development system which uses a two-component developer including a toner and a carrier. By the utilization of the present disclosure, it is possible to provide a development device which can suppress the occurrence of carrier development while stably maintaining the magnetic restriction force of a restriction member in the two-component development system and an image forming apparatus which includes such a development device.

What is claimed is:

1. An image forming apparatus comprising:
an image carrying member in which a photosensitive layer is formed on a surface;
a charging device that charges the surface of the image carrying member;
an exposure device that exposes the surface of the image carrying member charged by the charging device to form an electrostatic latent image on the surface of the image carrying member;
a development device that develops the electrostatic latent image formed on the surface of the image carrying member into a toner image;
an intermediate transfer belt to which the toner image formed on the image carrying member is primarily transferred;
a primary transfer roller that is pressed against the image carrying member via the intermediate transfer belt; and
a secondary transfer roller that secondarily transfers the toner image primarily transferred to the intermediate transfer belt onto a recording medium,
wherein the intermediate transfer belt is a hard resin belt,
the development device includes:
a development container that contains a two-component developer including a magnetic carrier and a toner; and
a developer carrying member that is rotatably supported by the development container and carries the developer on an outer circumferential surface,
the developer carrying member includes:
a development sleeve which carries the developer, in which a magnetic brush is formed on a surface and which is rotatable; and
a magnet in which a plurality of magnetic poles that are fixed in the development sleeve so as not to rotate and include a main pole disposed in a development region opposite the image carrying member relative to a direction of rotation of the development sleeve are spaced at predetermined intervals in a circumferential direction and
when a horizontal magnetic force gradient in a position where a horizontal magnetic force of the main pole is 0 [mT] is A, |A|≥3.74 is satisfied.

2. The image forming apparatus according to claim 1,
wherein the intermediate transfer belt is the resin belt a surface hardness of which is equal to or greater than 180 N/mm².

3. The image forming apparatus according to claim 1,
wherein only the main pole in the magnet includes a samarium-iron-nitrogen magnet.

4. The image forming apparatus according to claim 1,
wherein the photosensitive layer includes amorphous silicon.

5. The image forming apparatus according to claim 1,
wherein the development device further includes a restriction member that is disposed a predetermined distance from the developer carrying member opposite the developer carrying member,
the magnet further includes a restriction pole that is disposed in a restriction unit opposite the restriction member,
the restriction member is disposed on a downstream side relative to a position where a vertical magnetic force of the restriction pole is 0 [mT] in the direction of rotation of the development sleeve and on an upstream side relative to a position where the vertical magnetic force and a horizontal magnetic force of the restriction pole are equal to each other and
when the horizontal magnetic force gradient on an upstream side surface of the restriction member relative to the direction of rotation of the development sleeve is B, |B|≤1.37 is satisfied.
